(19) United States
(12) Patent Application Publication
(10) Pub. No.: US 2021/0398432 A1
(43) Pub. Date: Dec. 23, 2021

(54) VEHICLE CONTROL DEVICE AND VEHICLE INCLUDING THE SAME

(71) Applicant: LG ELECTRONICS INC., Seoul (KR)

(72) Inventors: Jaeseung BAE, Seoul (KR); Hyunho KI, Seoul (KR); Hansung KIM, Seoul (KR); Suho PARK, Seoul (KR); Changhun SUNG, Seoul (KR); Jaehwan YOON, Seoul (KR)

(73) Assignee: LG ELECTRONICS INC., Seoul (KR)

(21) Appl. No.: 16/490,482

(22) PCT Filed: Mar. 13, 2019
(86) PCT No.: PCT/KR2019/002900

§ 371 Date: Aug. 30, 2019

(51) Int. Cl. G08G 1/00

(52) U.S. Cl. CPC G08G 1/22

(57) ABSTRACT

The present invention provides a vehicle control device for controlling a vehicle. The vehicle may perform autonomous driving by the vehicle control apparatus. The vehicle control device includes: a communication unit configured to communicate with group vehicles included in a group; and a processor configured to transmit vehicle driving information of the vehicle via the communication unit so that platooning with the group vehicles is performed, wherein when a new vehicle is included in the group or scheduled to be included, the processor may determine an order number at which the new vehicle should be positioned in the group, and may control the communication unit so that the new vehicle is positioned at the order number.

### CROSS-REFERENCE TO RELATED APPLICATION

This application is the National Stage filing under 35 U.S.C. 371 of International Application No. PCT/KR2019/002900 filed on Mar. 13, 2019, which is hereby expressly incorporated by reference into the present application.

### TECHNICAL FIELD

The present invention relates to a vehicle control device capable of controlling at least one of a vehicle and electronic components provided in the vehicle, and a vehicle including the same.

### BACKGROUND

A vehicle refers to means of transporting people or goods by using kinetic energy. Representative examples of vehicles include automobiles and motorcycles.

For safety and convenience of a user who uses the vehicle, various sensors and devices are provided in the vehicle, and functions of the vehicle are diversified.

The functions of the vehicle may be divided into a convenience function for promoting driver's convenience, and a safety function for enhancing safety of the driver and/or pedestrians.

First, the convenience function has a development motive associated with the driver's convenience, such as providing infotainment (information+entertainment) to the vehicle, supporting a partially autonomous travel function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function is a technique of ensuring safeties of the driver and/or pedestrians, and may include various functions, such as a lane departure warning system (LDWS), a lane keeping assist system (LKAS), an autonomous emergency braking (AEB), and the like.

In addition, there is a platooning function in which a plurality of vehicles may maintain close to each other via a vehicle distance control to drive in one platoon (or group). The plurality of vehicles may exchange the moving of the vehicles and potentially abnormal situation information in the group via communication between the vehicles, and maintain the vehicle distance through the control according thereto.

When the platooning is performed, the fuel of the vehicles included in the group is saved, and since the distance between the vehicles is maintained narrow, the road occupancy rate of the vehicles is reduced and the congestion is mitigated.

The platooning may be performed through vehicle-to-everything communication (or V2X) or vehicle-to-vehicle communication (V2V). The group of the platooning includes a leader vehicle positioned at a forefront of the group and a follow vehicle following the leader vehicle. One or more follow vehicles receive driving information of the leader vehicle and move along the leader vehicle.

In general, the group is made by a group request of the follow vehicle and a group approval of the leader vehicle. Since the leader vehicle shares its own vehicle travel information, which may be called personal information, with the follow vehicle, approval is required. Requests and approvals are triggered by a user input of a passenger boarded on the vehicle.

The platooning has many advantages, but it is not popularized in that it requires requests and approvals between the passengers boarded on the leader vehicle and the follow vehicle.

### DISCLOSURE

### Technical Problem

The present invention is directed to solving the above-described problems and other problems.

The present invention is directed to providing a vehicle control device capable of maximizing efficiency of a new group, a control method thereof, and a vehicle including the same when a new vehicle is included in a group.

### Technical Solution

The present invention relates to a vehicle control device for controlling a vehicle, a vehicle including the same, and a vehicle control method of a vehicle communication system including a plurality of vehicles.

According to one embodiment, the vehicle control device includes: a communication unit configured to communicate with group vehicles included in a group; and a processor configured to transmit vehicle travel information of the vehicle via the communication unit so that platooning with the group vehicles is performed, wherein when a new vehicle is included in the group or scheduled to be included, the processor may determine an order number at which the new vehicle should be positioned in the group, and may control the communication unit so that the new vehicle is positioned at the order number.

According to one embodiment, the processor may determine the order number based on the new vehicle, and the order number may be determined differently depending on the new vehicle.

According to one embodiment, the processor may determine the order number by using a fuel saving amount expected at the time of platooning of the group vehicles and the new vehicle.

According to one embodiment, the processor may select any one order number at which the fuel saving amount becomes maximum among a plurality of order numbers at which the new vehicle may be positioned in the group.

According to one embodiment, the processor may determine the order number based on at least one of position, speed, type, size, and length of the new vehicle.

According to one embodiment, the processor may divide the group into a first group including the new vehicle and a second group not including the new vehicle, and may control the communication unit so that individual platooning in each group is performed.

According to one embodiment, the processor may determine at least one of a leader vehicle of the first group and a leader vehicle of the second group, and may control the communication unit so that platooning is performed by the determined leader vehicle.

According to one embodiment, the processor may determine whether to divide the group into the first group and the second group depending on a predetermined condition.

According to one embodiment, the processor may calculate at least one of a size and a length of the group including the new vehicle, and determine whether to divide the group into the first group and the second group depending on whether the at least one satisfies the predetermined condition.

According to one embodiment, the processor may generate at least one moving scenario of the new vehicle and the group vehicles for which the new vehicle is positioned at the order number, and may control the communication unit so that the at least one moves according to the moving scenario.

According to one embodiment, the communication unit may perform communication with a display provided in the vehicle, and the processor may control the communication unit so that a guidance video guiding the moving scenario is displayed on the display.

According to one embodiment, the processor may modify the moving scenario based on a user input entered while the guidance video is displayed on the display, and may control the communication unit so that the at least one moves according to the modified moving scenario.

According to one embodiment, the processor may set a sub-leader vehicle leading a sub-group and a sub-follow vehicle following the sub-leader vehicle when the moving scenario is generated, and may control the communication unit so that the sub-group performs a platooning according to the moving scenario.

According to one embodiment, when the sub-group is set, the processor may limit to transmit the vehicle travel information to the sub-follow vehicle.

According to one embodiment, the processor may resume to transmit the vehicle travel information to the sub-follow vehicle when the sub-group is released.

According to one embodiment, the processor may release the sub-group based on a distance between the sub-leader vehicle and a vehicle positioned in front of the sub-leader vehicle.

According to one embodiment, the processor may select any one of the group vehicles as the sub-leader vehicle based on at least one of position, type, height, length, and speed of each group vehicle.

In addition, a control method of the vehicle control device may include: transmitting vehicle travel information of a vehicle so as to perform a platooning with group vehicles included in a group; determining an order number at which the new vehicle should be positioned in the group when a new vehicle is included in the group or scheduled to be included; and controlling at least one of the new vehicle and the group vehicles so that the new vehicle is positioned at the order number.

According to one embodiment, the controlling of the at least one of the new vehicle and the group vehicles may include: generating the at least one moving scenario of the new vehicle and the group vehicles for which the new vehicle is positioned at the order number; and controlling the at least one based on the moving scenario.

According to one embodiment, the controlling of the at least one of the new vehicle and the group vehicles may further include: setting a sub-leader vehicle leading a sub-group and a sub-follow vehicle following the sub-leader vehicle; and controlling the sub-leader vehicle so that the sub-group performs a platooning according to the moving scenario.

### Advantageous Effects

In the present invention, descriptions with respect to effects of a vehicle control device for controlling a vehicle, a control method thereof, and a vehicle including the same are as follow.

According to the present invention, when a new vehicle is included in a platooning, the new vehicle is not positioned at a rear of the group, but any one order number at which fuel saving is maximized among a plurality of order numbers at which the new vehicle may be positioned, is selected based on the new vehicle. In this manner, a new effect of maximizing fuel saving, which is a top goal of performing platooning, occurs.

### BRIEF DESCRIPTION OF THE DRAWINGS

FIG. 1 is a block diagram for describing a vehicle control device according to the present invention.

FIG. 2 is a block diagram for describing a vehicle control device for controlling a plurality of vehicles.

FIG. 3 is a flowchart for describing an operation of a leader vehicle, a follow vehicle, and a candidate vehicle for a platooning.

FIG. 4 is a flowchart for describing an operation of a vehicle control device for controlling a vehicle.

FIG. 5 is an illustrative view for describing an order number at which a new vehicle may be included in a group.

FIG. 6 is a flowchart for describing a method of dividing a group into at least two sub-groups when a new vehicle is included in the group.

FIG. 7 is an illustrative view for describing the method of FIG. 6.

FIG. 8 is a flowchart for describing a method of generating a moving scenario when a new vehicle is included in a group.

FIG. 9 is a flowchart for describing a method of generating a moving scenario for a sub-group.

FIG. 10 is an illustrative view for describing the method of FIG. 9.

FIG. 11 is a flowchart for describing an operation of a vehicle control device related to a sub-group.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

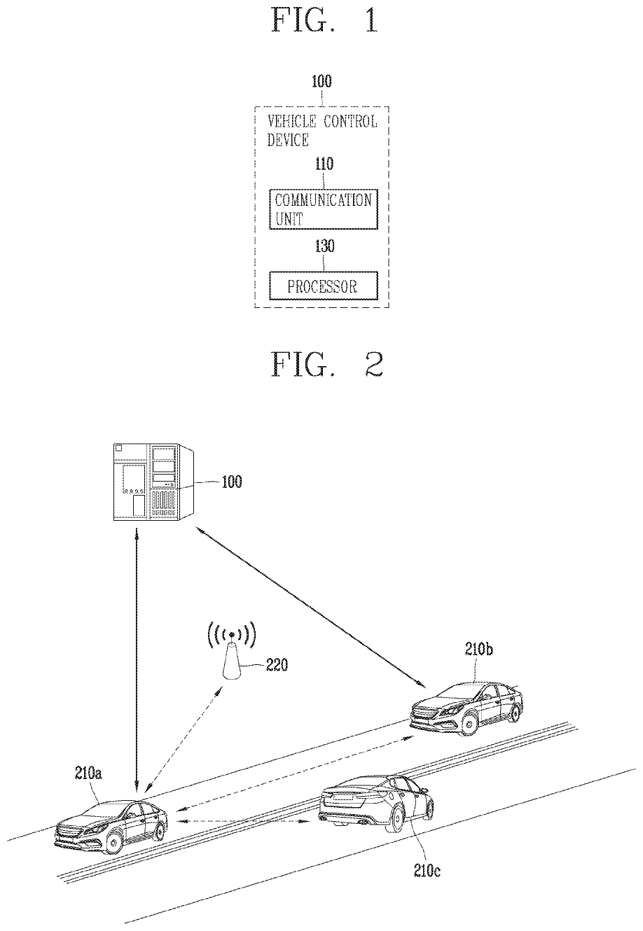

FIG. 1 is a block view illustrating a vehicle control device according to an embodiment of the present invention.

The vehicle control device refers to a device for controlling the vehicle.

For example, the vehicle control device may be a device mounted on a vehicle to perform communication through CAN communication and generate messages for controlling the vehicle and/or electric components mounted on the vehicle.

As another example, the vehicle control device may be located outside the vehicle, like a server or a communication device, and may perform communication with the vehicle through a mobile communication network. In this case, the vehicle control device can remotely control the vehicle and/or the electric components mounted on the vehicle using the mobile communication network.

The vehicle control device 100 is provided in the vehicle, and may be implemented as an independent device detachable from the vehicle or may be integrally installed on the vehicle to construct a part of the vehicle 100.

Referring to FIG. 1, the vehicle control device 100 includes a communication unit 110 and a processor 130.

The communication unit 110 is configured to perform communications with various components provided in the vehicle. For example, the communication unit 110 may receive various information provided through a controller area network (CAN). In another example, the communication unit 110 may perform communication with all devices capable of performing communication, such as a vehicle, a mobile terminal, a server, and another vehicle. This may be referred to as Vehicle to everything (V2X) communication. The V2X communication may be defined as a technology of exchanging or sharing information, such as traffic condition and the like, while communicating with a road infrastructure and other vehicles during driving.

The communication unit 110 may receive information related to the travel of the vehicle from most of electric components in the vehicle 100. The information transmitted from the electric component provided in the vehicle to the vehicle control device 100 is referred to as ‘vehicle driving information (or vehicle travel information)’.

Vehicle travel information includes vehicle information and surrounding information related to the vehicle. Information related to an inside of the vehicle with respect to a frame of the vehicle 100 may be defined as the vehicle information, and information related to an outside of the vehicle may be defined as the surrounding information.

The vehicle information refers to information related to the vehicle itself. For example, the vehicle information may include a traveling speed, a traveling direction, an acceleration, an angular velocity, a location (GPS), a weight, a number of passengers in the vehicle, a braking force of the vehicle, a maximum braking force, air pressure of each wheel, a centrifugal force applied to the vehicle, a travel mode of the vehicle (autonomous travel mode or manual travel mode), a parking mode of the vehicle (autonomous parting mode, automatic parking mode, manual parking mode), whether or not a user is present in the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a front-side (rear-side) vehicle, a relative speed of a front-side (rear-side) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may include ambient brightness, temperature, a position of the sun, information related to nearby subject (a person, another vehicle, a sign, etc.), a type of a driving road surface, a landmark, line information, and driving lane information, and information required for an autonomous travel/autonomous parking/automatic parking/manual parking mode.

In addition, the surrounding information may further include a distance from an object existing around the vehicle to the vehicle, collision possibility, a type of an object, a parking space for the vehicle, an object for identifying the parking space (for example, a parking line, a string, another vehicle, a wall, etc.), and the like.

The vehicle travel information is not limited to the example described above and may include all information generated from the components provided in the vehicle.

Meanwhile, the processor 130 is configured to control one or more electric components provided in the vehicle using the communication unit 110.

Specifically, the processor 130 may determine whether or not at least one of a plurality of preset conditions is satisfied, based on vehicle travel information received through the communication unit 110. According to a satisfied condition, the processor 130 may control the one or more electric components in different ways.

In connection with the preset conditions, the processor 130 may detect an occurrence of an event in an electric component provided in the vehicle and/or application, and determine whether the detected event meets a preset condition. At this time, the processor 130 may detect the occurrence of the event from information received through the communication unit 110.

The application is a concept including a widget, a home launcher, and the like, and refers to all types of programs that can be run on the vehicle. Accordingly, the application may be a program that performs a function of a web browser, a video playback, a message transmission/reception, a schedule management, or an application update.

Further, the application may include a forward collision warning (FCW), a blind spot detection (BSD), a lane departure warning (LDW), a pedestrian detection (PD) A Curve Speed Warning (CSW), and a turn-by-turn navigation (TBT).

For example, the event occurrence may be a missed call, presence of an application to be updated, a message arrival, start on, start off, autonomous travel on/off, pressing of an LCD awake key, an alarm, an incoming call, a missed notification, and the like.

As another example, the occurrence of the event may be a generation of an alert set in the advanced driver assistance system (ADAS), or an execution of a function set in the ADAS. For example, the occurrence of the event may be a occurrence of forward collision warning, an occurrence of a blind spot detection, an occurrence of lane departure warning, an occurrence of lane keeping assist warning, or an execution of autonomous emergency braking.

As another example, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various electronic control units (ECUs) provided in the vehicle perform specific functions, it may be determined as the occurrence of the event.

For example, when a generated event satisfies the preset condition, the processor 130 may control the communication unit 110 to display information corresponding to the satisfied condition on one or more displays provided in the vehicle.

Meanwhile, the vehicle control device 100 may perform a function related to platooning in which a plurality of vehicles form a group.

For example, a leader vehicle of the group may transmit its own vehicle travel information to a follow vehicle included in the group. For another example, a follow vehicle in the group may perform platooning based on the vehicle travel information received from the leader vehicle. The vehicle control device provided in the follow vehicle may transmit a control message to one or more electronic components provided in the follow vehicle based on the vehicle travel information of the leader vehicle.

The communication unit 110 of the vehicle control device 100 is configured to perform communication with other vehicles positioned within a predetermined range. For example, the predetermined range may be a communicable distance for performing the platooning.

The processor 130 performs the communication with the other vehicles via the communication unit so as to perform the platooning. The processor 130 may share the vehicle travel information of its own vehicle with the other vehicle, or may receive the vehicle travel information of the other vehicle to use it for the platooning.

FIG. 2 is a block diagram for describing a vehicle control device for controlling a plurality of vehicles.

The vehicle control device 100 may be mounted on a vehicle to control the vehicle, and may control the vehicle remotely using a wireless network in a state in which the vehicle control device 100 is not mounted on the vehicle.

The communication unit 110 is configured to perform controller area network (CAN) communication when the vehicle control device 100 is mounted on the vehicle, and may be configured to perform wireless communication via a wireless network 220 when the vehicle control device 100 is not mounted on the vehicle. In other words, the communication unit 110 may be configured to perform different methods of communication according to the type of the vehicle control device.

The vehicle control device 100 may correspond to a server, a base station, or an infrastructure of V2I, and may communicate with one or more vehicles 210a to 210c and may generate a control message for controlling each vehicle.

For example, the vehicle control device 100 may receive first vehicle travel information generated at a first vehicle 210a from the first vehicle 210a, and generate a control message for controlling the first vehicle 210a based on the first vehicle travel information.

The control message may be associated with various control functions such as, setting a destination of the first vehicle 210a, changing a driving mode, controlling a brake, engine, motor, etc. so that speed is changed, controlling a steering device so that a driving direction is changed, or the like.

Hereinafter, an operation of the vehicle control device 100 will be described in more detail with reference to the accompanying drawings.

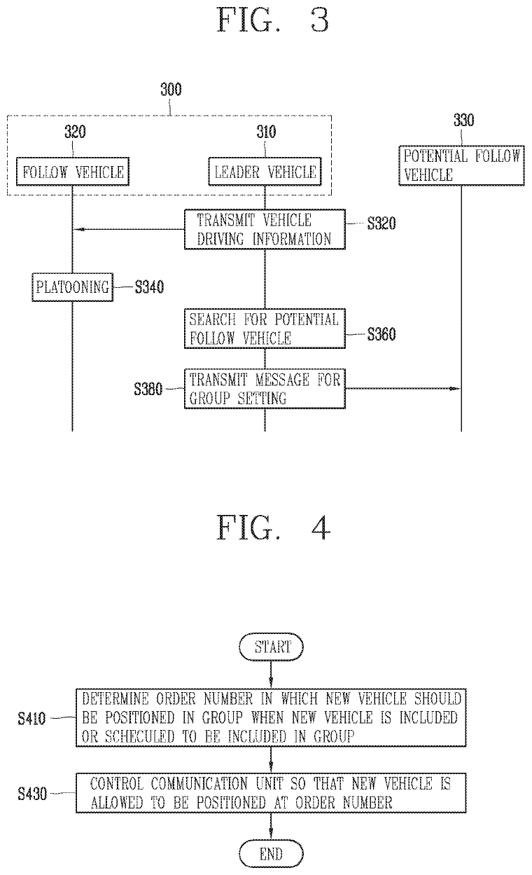

FIG. 3 is a flowchart for describing an operation of a leader vehicle, a follow vehicle, and a potential follow vehicle for platooning.

Platooning refers to driving such that the distance between a front vehicle and a rear vehicle among a plurality of vehicles consecutively positioned is maintained within a predetermined range. The plurality of vehicles drive in one group, and consist of a leader vehicle positioned at a forefront and one or more follow vehicles that follow the leader vehicle.

Vehicles 310 and 320 included in a group 300 are each provided with the above-described vehicle control device 100 in FIG. 1, and share vehicle travel information generated from each vehicle via the communication unit 110 of the vehicle control device 100.

As disclosed below, an operation of the leader vehicle 310 is performed by a processor 130 of the vehicle control device 100 provided in the leader vehicle 310 and an operation of the follow vehicle 320 is performed by the processor 130 of the vehicle control device 100 provided in the leader vehicle 310.

One group 300 includes one leader vehicle 310 and at least one follow vehicle 320.

The leader vehicle 310 is positioned at the forefront of the group 300, and transmits its own vehicle travel information to the follow vehicle 320 included in the group 300 via inter-vehicle communication (V2X) (S320).

For example, the vehicle travel information of the leader vehicle 310 including a speed, acceleration, a driving direction and the like of the leader vehicle 310 may be transmitted to the follow vehicle 320.

The follow vehicle 320 performs the platooning following (or tracking) the leader vehicle 310 by using the vehicle travel information of the leader vehicle 310 received from the leader vehicle 310 (S340).

The follow vehicle 320 performs the driving so as to maintain a predetermined distance from the preceding vehicle. For example, a speed of the follow vehicle 320 may be adjusted by accelerating or decelerating so that a distance of 10 m or less from the preceding vehicle is maintained. A speed of the follow vehicle 320 may be adjusted or a driving radius may be changed by using the vehicle travel information of the leader vehicle 310 received from the leader vehicle 310.

The follow vehicle 320 may determine a predetermined speed and a predetermined driving direction at predetermined coordinates by using the vehicle travel information of the leader vehicle 310. When the follow vehicle 320 is positioned at the predetermined coordinates, control is performed so as to have the predetermined speed and the predetermined driving direction.

The leader vehicle 310 may communicate with vehicles positioned within a predetermined range, and search for a potential follow vehicle that coincides with at least part of the moving path of the leader vehicle 310 (S360). One or more potential follow vehicles may be searched.

A potential follow vehicle 330 is defined as a vehicle that may or should be the follow vehicle 320. The potential follow vehicle 330 may be searched by the leader vehicle 310. Alternatively, any of vehicles may transmit a group request message to the leader vehicle 310 to become a potential follow vehicle 330. The leader vehicle 310 may respond to the group request message to include any of the vehicles in the potential follow vehicle 330.

The leader vehicle 310 may search for a potential follow vehicle based on sensing information sensed by a sensor provided in the leader vehicle 310. In addition, the potential follow vehicle may be searched by using the inter-vehicle communication (V2X), or the potential follow vehicle may be searched by using the telematics communication.

The leader vehicle 310 may search for a potential follow vehicle that coincides with at least part of the moving path of the leader vehicle 310 based on a road on which the leader vehicle 310 is driving. For example, when another vehicle travel on the same road in the same direction within a predetermined range is sensed, the other vehicle may be searched as a potential follow vehicle based on the sensing information.

In another example, a destination of the other vehicle and/or a moving path of the other vehicle may be received by the inter-vehicle communication, and a potential follow vehicle that coincides with at least part of the moving path of the leader vehicle 310 may be searched based on received information. The leader vehicle 310 may receive other vehicle information including at least one of a destination and an expected moving path of each vehicle from vehicles positioned within a predetermined range. In addition, based on the other vehicle information, a potential follow vehicle in which at least part of the moving path of the leader vehicle 310 coincides may be searched.

As still another example, the leader vehicle 310 may communicate with a server that receives a path of each vehicle. The leader vehicle 310 may transmit its position to the server, and the server may search for a potential follow vehicle coinciding with at least part of the moving path based on the position of the leader vehicle 310 to transmit it to the leader vehicle 310. The leader vehicle 310 may search for the potential follow vehicle based on information received from the server.

At least one of a size and shape of the predetermined range may vary depending on a speed of the leader vehicle 310. For example, when the speed of the leader vehicle 310 is within a first range, a predetermined range of a first size is set, but when the speed of the leader vehicle 310 is within a second range faster than the first range, a predetermined range of a second size smaller than the first size may be set. This is to ensure higher safety because as the speed of the vehicle increases, the risk of an accident that may occur in the vehicle increases.

The leader vehicle 310 may transmit a message so that the leader vehicle 310 and the potential follow vehicle 330 are set as one group in response to the search for the potential follow vehicle 330 (S380).

Specifically, the message may be transmitted to the potential follow vehicle 330 via the communication unit 110 of the vehicle control device 100 provided in the leader vehicle 310.

The message may include various information necessary for the potential follow vehicle 330 to be included in the group. For example, ID and security code of the leader vehicle 310 necessary for communication with the leader vehicle 310, and the vehicle travel information of the leader vehicle 310 may be included.

Hereinafter, an operation of a vehicle control device 100 for controlling at least one of a leader vehicle 310 and a follow vehicle 320 included in the group will be described in detail.

The vehicle control device 100 may be mounted on the leader vehicle 310, or may correspond to a server, a base station, or an infrastructure of V2I. Hereinafter, for convenience of description, an example will be described in which the vehicle control device 100 is mounted on the leader vehicle 310 to performs various controls related to the leader vehicle 310.

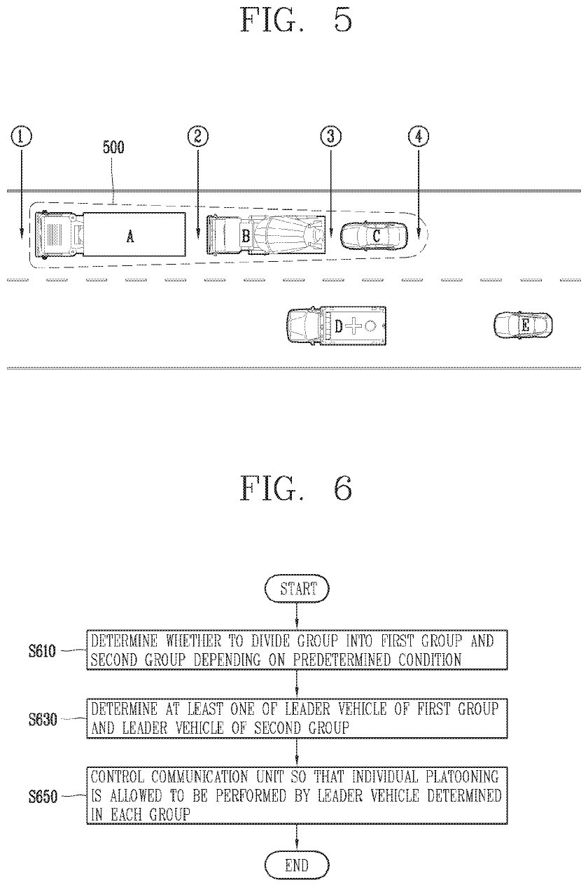

FIG. 4 is a flowchart for describing an operation of a vehicle control device for controlling a vehicle, and FIG. 5 is an illustrative view for describing an order number at which a new vehicle may be included in a group.

As described above with reference to FIG. 1, the vehicle control device 100 includes a communication unit 110 and a processor 130.

The communication unit 110 communicates with one or more follow vehicles set as a group.

The processor 130 may receive vehicle travel information of a vehicle controlled by the vehicle control device 100 from one or more electric components provided in the vehicle via the communication unit 110.

Further, the processor 130 may receive follow vehicle travel information generated in a follow vehicle from the follow vehicle via the communication unit 110.

The processor 130 transmits the vehicle travel information to the one or more follow vehicles via the communication unit 110 so that a platooning with the one or more follow vehicles is performed.

The processor 130 may communicate with a new vehicle not included in a group 300 via the communication unit 110. For example, the new vehicle may be the above-described candidate vehicle 330 in FIG. 3. The processor 130 may determine whether to include the new vehicle in the group 300 depending on a result of the communication.

Here, ‘the new vehicle is included in the group 300’ refers that the new vehicle performs a platooning based on the vehicle travel information provided by the processor 130. The platooning includes not only performing the platooning in accordance with a group formation, but also moving from a position not designated in the group formation to a position designated in the group formation to form the group formation.

The processor 130 may determine the order number at which the new vehicle should be positioned in the group 300 when the new vehicle is included or scheduled to be included in the group 300 (S410).

The processor 130 may determine the order number of the new vehicle based on the new vehicle. The order number is determined differently depending on the new vehicle.

The processor 130 may receive information on the new vehicle (hereinafter, referred to as ‘new vehicle information’) from the new vehicle, and may determine the order number by using the new vehicle information. Specifically, the processor 130 may determine the order number based on at least one of the position, speed, type, size, and length of the new vehicle included in the new vehicle information.

The processor 130 may calculate a fuel saving amount expected at the time of platooning of the group vehicles included in the group and the new vehicle based on the new vehicle information, and may determine the order number based on the fuel saving amount. The processor 130 may select any one order number at which the fuel saving amount becomes maximum among a plurality of order numbers at which the new vehicle may be positioned in the group.

The processor 130 may calculate a fuel consumption amount, and may select an order number at which the fuel consumption amount becomes minimum.

The processor 130 may calculate the fuel saving amount of each vehicle, and may sum the fuel saving amount of an entire group.

The processor 130 may set a virtual boundary line 510 for managing the group. The processor 130 may determine a group leaving of any vehicle included in the group or a group entering of a new vehicle by using the boundary line 510. Further, information related to the boundary line 510 may be transmitted to an external vehicle so that the external vehicle not included in the group is prevented from entering the boundary line 510.

The boundary line 510 may be defined by an external shape of each vehicle included in the group. For example, as shown in FIG. 5, three vehicles of A, B, and C may perform the platooning in order of large size to save fuel. In other words, the vehicle A having a largest size may precede, the vehicle B having a smaller size than that of the vehicle A may follow the vehicle A, and the vehicle C having a smaller size than that of the vehicle B may follow the vehicle B. Accordingly, the boundary line 510 may have a trapezoidal shape (a pair of opposite sides are parallel, and one side is smaller in length than the other side).

The processor 130 may calculate an estimated fuel saving amount at the time of the platooning by using the boundary line. Further, a new vehicle D or E may be added to the group to specify a new boundary line, and the fuel saving amount may be calculated by using the specified new boundary line.

As shown in FIG. 5, a group 500 may include the three vehicles including A, B, and C. The processor 130 may search for D and E as candidate vehicles that may be included in the group 500. The order number at which the new vehicle may be positioned in the group 500 is configured with four kinds from numbers one to four.

The order number at which D is included in the group and the order number at which E is included in the group may vary. Since the vehicle D is smaller than the vehicle B and larger than the vehicle C, the order number of the vehicle D may be determined to be number three. On the other hand, since the vehicle E is smaller than the vehicle C, the order number of the vehicle E may be determined to be number four.

Next, the processor 130 may control the communication unit 110 so that the new vehicle is positioned at the order number (S430).

The processor 130 may adjust a speed of at least one of a leader vehicle 310 and a follow vehicle 320.

The processor 130 may determine at least one of a time and a point at which the new vehicle begins to enter the boundary line 510, and may transmit the determined at least one to the new vehicle.

Although not shown in the drawings, the processor 130 may output boundary line guidance information for guiding the boundary line to a display provided in the vehicle. Specifically, the processor 130 may control the communication unit 110 so that the boundary line guidance information is displayed on the display.

Order number guidance information for guiding the order number at which the new vehicle should be positioned may be output on the display. Further, when the new vehicle is positioned at a candidate order number for which the new vehicle may be positioned and each candidate order number, the generated fuel saving amount may also be included in the order number guidance information.

According to the present invention, when the new vehicle is included in the platooning, the new vehicle is not positioned at a rear of the group, but any one order number at which the fuel saving amount is maximized among a plurality of order numbers at which the new vehicle may be positioned, is selected based on the new vehicle. In this manner, a new effect of maximizing fuel saving, which is a top goal of performing platooning, occurs.

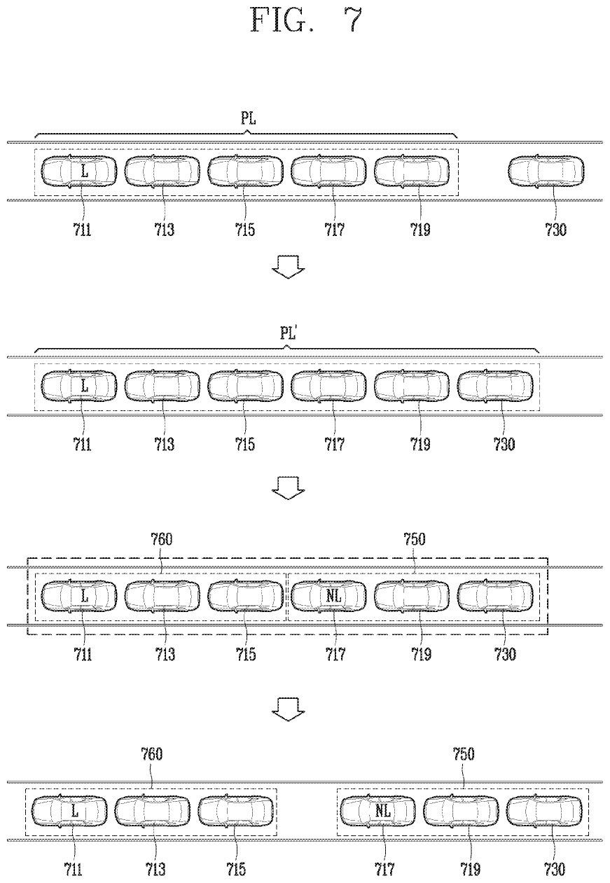

FIG. 6 is a flowchart for describing a method of dividing a group into at least two sub-groups when a new vehicle is included in the group, and FIG. 7 is an illustrative view for describing the method of FIG. 6.

The processor 130 may determine whether to divide a group into a first group and a second group depending on a predetermined condition (S610).

The processor 130 calculates at least one of a size and a length of the group including the new vehicle, and determines whether to divide the group into the first group and the second group depending on whether the at least one satisfies the predetermined condition.

An optimal number of vehicles and/or an optimal length of the group for maintaining the group by the processor 130 may be preset to the predetermined condition.

The optimal number and/or the optimal length may vary depending on a reference condition. The reference condition may be defined by at least one of performance of the vehicle control device 100, characteristics of a road on which a group is driving, weather, and a communication speed between vehicles of platooning. The processor 130 may determine the optimal number and/or the optimal length based on the reference condition, and may set the predetermined condition based on the determined optimal number and/or the determined optimal length.

For example, when a communication distance between vehicles is reduced due to weather deterioration, the optimal number and/or the optimal length may be changed. This is to ensure a safe platooning.

When the new vehicle is included in the group while the optimal number is set to a natural number n, the vehicle included in the group may be n+1. In this case, the processor 130 may divide the group into a first group and a second group based on the optimal number.

When the new vehicle is included in the group while the optimal length is set to a real number m, a group length may be longer than m. In this case, the processor 130 may divide the group into a first group and a second group based on the optimal length.

For convenience of description, an example of dividing the group by using the group length will be described in detail.

As shown in FIG. 7, a group includes a leader vehicle L and at least one follow vehicle. The processor 130 may calculate a group length PL.

The processor 130 may calculate the group length PL based on one point of the vehicle positioned at a forefront of the group and one point of the vehicle positioned at a rear end of the group. The group length PL may be calculated including a distance between the group vehicles, and a length of each of the group vehicles. For example, when the length of a first vehicle is 2 m, the length of a second vehicle is 3 m, and the distance between the first vehicle and the second vehicle is 1 m, the group length may be 6 m.

The group length PL may be calculated by a boundary line of the group.

When a new vehicle is included or scheduled to be included in the group, the processor 130 may calculate an expected group length PL′ when the new vehicle is included in the group.

Here, the expected group length PL′ corresponds to the group length of the new group including the new vehicle in state of assuming that the new vehicle is positioned at the order number determined by the processor 130 and performs the platooning.

When the expected group length PL′ is greater than an optimal length, the processor 130 may determine dividing of the group. When the expected group length PL′ is less than or equal to the optimal length, the processor 130 may determine not to divide the group.

When the processor 130 determines to divide the group, the group may be divided into a first group including the new vehicle and a second group not including the new vehicle.

In this case, the processor 130 may determine at least one of the leader vehicle of the first group and the leader vehicle of the second group (S630).

Vehicles included in the first group and vehicles included in the second group are distinguished, and at least one of the leader vehicle of the first group and the leader vehicle of the second group is determined.

The processor 130 may divide the group into a plurality of sub-groups that satisfy the predetermined condition and maximize a fuel saving amount (or minimize a fuel consumption amount). The leader vehicle of each sub-group may be determined based on the vehicles included in the sub-group.

Next, the processor 130 may control the communication unit 110 so that individual platooning is performed by the leader vehicle determined in each group (S650).

The processor 130 determines at least one of the leader vehicle of the first group and the leader vehicle of the second group, and controls the communication unit 110 so that the platooning is performed by the determined leader vehicle.

For example, as shown in FIG. 7, a group including six vehicles 711 to 719 may be divided into a first group 750 and a second group 760 as a new vehicle 730 is included. In addition, a leader vehicle 717 of the first group 750 and a leader vehicle 711 of the second group 760 may be determined. The vehicles 719 and 730 included in the first group 750 perform the platooning based on the vehicle travel information provided by the leader vehicle 717 of the first group 750, and the vehicles 713 and 715 included in the second group 760 perform the platooning based on the vehicle travel information provided by the leader vehicle 711 of the second group 760.

When a new vehicle is included in the group, the group may be divide into a plurality of sub-groups according to a predetermined condition. Accordingly, there are effects that the group is efficiently managed and the fuel consumption is minimized. The predetermined condition is variable according to driving environment, thereby achieving optimal safety.

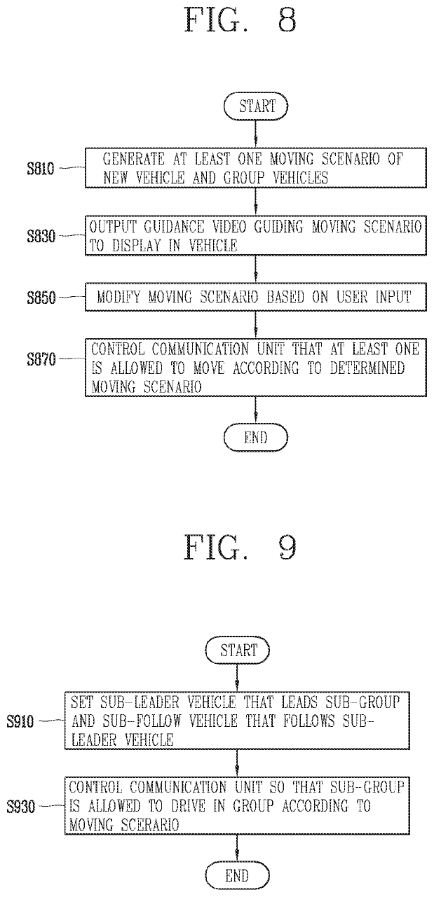

FIG. 8 is a flowchart for describing a method of generating a moving scenario when a new vehicle is included in a group.

The processor 130 may generate at least one moving scenario of a new vehicle and group vehicles (S810).

The processor 130 generates at least one moving scenario of the new vehicle and the group vehicles for which the new vehicle is positioned at the order number.

The moving scenario includes a moving path for which a new vehicle enters inside a boundary line of the group from outside of the boundary line of the group to position at the order number determined by the processor 130. Further, a moving path of a group vehicle that makes space within the boundary line of the group so that the new vehicle enters the boundary line of the group, may be included in the moving scenario.

The processor 130 may select a starting point and/or a starting time at which the new vehicle is included in the group based on the driving path of the group. The starting point and/or starting time may vary depending on the driving path. For example, when a ramp region that may interfere with driving of another vehicle is positioned in front, a point beyond a predetermined distance based on the ramp region may be selected as the starting point.

The processor 130 generates a moving path of at least one vehicle from the starting point as the moving scenario. The moving scenario may vary depending on characteristics of a road on which driving is expected.

As the moving scenario is determined, the processor 130 may control at least one of the group vehicle and the new vehicle based on the moving scenario. Accordingly, moving of the vehicle corresponding to the moving scenario is performed.

The processor 130 may output a guidance video guiding the moving scenario to a display inside the vehicle (S830).

Specifically, the communication unit 110 may communicate with the display provided in the vehicle. In addition, the processor 130 may control the communication unit 110 so that the guidance video guiding the moving scenario is displayed on the display.

The processor 130 may visualize the moving scenario to guide to passengers the moving path of the group vehicles and the new vehicle included in the group. For example, when a third vehicle is scheduled to be included in the group in a state in which first and second vehicles are included in the group, the processor 130 may generate a moving scenario including the first to third vehicles, and may generate an animation (or video) corresponding to the moving scenario.

When the animation is played back, graphic objects corresponding to the first to third vehicles are displayed on an image corresponding to the road on which the driving is scheduled, and at least one vehicle moves according to the moving scenario. An arrow guiding at least one of a moving direction, speed, and acceleration of each vehicle may be displayed together with the graphic object. Further, a progress bar formed for adjusting a playback point of the moving scenario may be displayed.

The processor 130 may modify the moving scenario based on a user input (S850).

For example, the moving scenario may be modified in response to a touch input to at least one of the graphical objects included in the animation. The position of each vehicle in the group may be changed, or the moving path may be changed. The time and/or point at which the moving scenario starts may be changed.

The processor 130 may control the communication unit 110 so that the at least one may move according to the finalized moving scenario (S870).

Passengers may confirm changes in the platooning via the animation corresponding to the moving scenario, and may change the moving scenario as they desire.

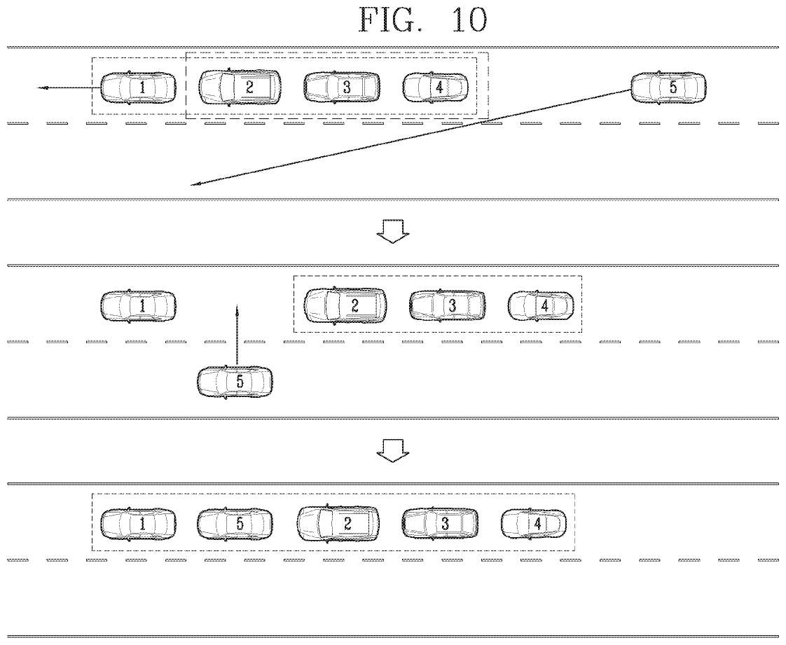

FIG. 9 is a flowchart for describing a method of generating a moving scenario for a sub-group, and FIG. 10 is an illustrative view for describing the method of FIG. 9.

The processor 130 may set a sub-leader vehicle that leads a sub-group and a sub-follow vehicle that follows the sub-leader vehicle (S910).

The processor 130 may select any one of the group vehicles as the sub-leader vehicle based on at least one of a position, type, height, length, and speed of each group vehicle.

For example, as shown in FIG. 10, it may be scheduled that a fifth vehicle is included in the group while first to fourth vehicles are in platooning. The processor 130 may determine an order number of the fifth vehicle to be between the first vehicle and the second vehicle. A moving scenario in which the fifth vehicle is positioned between the first vehicle and the second vehicle is generated. In this case, the second vehicle is set as a sub-leader vehicle, and the third and fourth vehicles positioned behind the second vehicle may be set as sub-follow vehicles. The second to fourth vehicles are set as a sub-group.

The processor 130 may control the communication unit so that the sub-group performs the platooning according to the moving scenario (S930).

The sub-group performs the platooning based on vehicle travel information provided by the sub-leader vehicle instead of the leader vehicle. The sub-leader vehicle performs driving according to the moving scenario, and provides the vehicle travel information of the sub-leader vehicle to the sub-follow vehicle included in the sub-group.

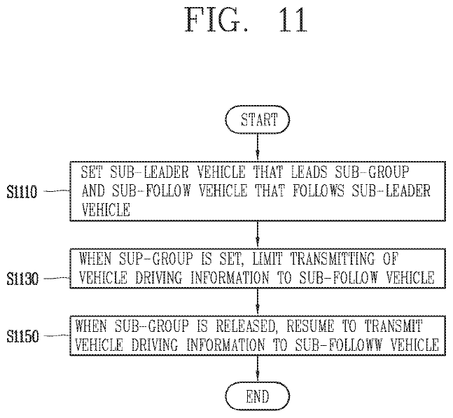

FIG. 11 is a flowchart for describing an operation of a vehicle control device related to a sub-group.

The sub-group, a sub-leader vehicle that leads the sub-group, and a sub-follow vehicle that follows the sub-leader vehicle may be set (S1110).

The sub-follow vehicle performs a platooning based on vehicle travel information of the sub-leader vehicle provided by the sub-leader vehicle.

The processor 130 controls the sub-leader vehicle via the communication unit 110 so that the sub-group performs the platooning according to the moving scenario.

When the sub-group is set, transmitting of the vehicle travel information to the sub-follow vehicle may be limited (S1130).

The leader vehicle stops the transmitting of the vehicle travel information to the vehicles included in the sub-group. This is to prevent occurrence of a collision or contradiction between data in advance when the vehicle travel information of the leader vehicle and the vehicle travel information of the sub-leader vehicle are received at the same time.

The processor 130 may release the sub-group based on a distance between the sub-leader vehicle and a vehicle positioned in front of the sub-leader vehicle. When the sub-group is released, the sub-leader vehicle and the sub-follow vehicle are changed to follow vehicles following the leader vehicle.

When the sub-group is released, the vehicle travel information may be resumed to be transmitted to the sub-follow vehicle (S1150).

When the sub-group is released, platooning is performed by the leader vehicle instead of the sub-leader vehicle. Therefore, the sub-leader vehicle stops the transmitting of the vehicle travel information of the sub-leader vehicle. The leader vehicle transmits the vehicle travel information of the leader vehicle to the sub-leader vehicle and the sub-follow vehicle included in the sub-group.

The foregoing present disclosure may be implemented as codes (an application or software) readable by a computer on a medium written by the program. The control method of the above-described autonomous vehicle may be implemented by codes stored in a memory or the like.

The computer-readable media may include all kinds of recording devices in which data readable by a computer system is stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

1. A vehicle control device for controlling a vehicle comprising:
a communication unit configured to communicate with group vehicles included in a group; and
a processor configured to transmit vehicle travel information of the vehicle via the communication unit so that platooning with the group vehicles is performed,
wherein when a new vehicle is included in the group or scheduled to be included, the processor determines an order number at which the new vehicle should be positioned in the group, and controls the communication unit so that the new vehicle is positioned at the order number.

2. The vehicle control device of claim 1, wherein the processor determines the order number based on the new vehicle, and the order number is determined differently depending on the new vehicle.

3. The vehicle control device of claim 2, wherein the processor determines the order number by using the fuel saving amount expected at the time of platooning of the group vehicles and the new vehicle.

4. The vehicle control device of claim 3, wherein the processor selects any one order number at which the fuel saving amount becomes maximum among a plurality of order numbers at which the new vehicle may be positioned in the group.

5. The vehicle control device of claim 2, wherein the processor determines the order number based on at least one of position, speed, type, size and length of the new vehicle.

6. The vehicle control device of claim 1, wherein the processor divides the group into a first group including the new vehicle and a second group not including the new vehicle, and controls the communication unit so that individual platooning in each group is performed.

7. The vehicle control device of claim 6, wherein the processor determines at least one of a leader vehicle of the first group and a leader vehicle of the second group, and controls the communication unit so that platooning is performed by the determined leader vehicle.

8. The vehicle control device of claim 6, wherein the processor determines whether to divide the group into the first group and the second group depending on a predetermined condition.

9. The vehicle control device of claim 8, wherein the processor calculates at least one of a size and a length of the group including the new vehicle, and determines whether to divide the group into the first group and the second group depending on whether the at least one satisfies the predetermined condition.

10. The vehicle control device of claim 1, wherein the processor generates at least one moving scenario of the new vehicle and the group vehicles for which the new vehicle is positioned at the order number and controls the communication unit so that the at least one moves according to the moving scenario.

11. The vehicle control device of claim 10, wherein the communication unit performs communication with a display provided in the vehicle, and the processor controls the communication unit such that a guidance video guiding the moving scenario is displayed on the display.

12. The vehicle control device of claim 11, wherein the processor modifies the moving scenario based on a user input entered while the guidance video is displayed on the display, and controls the communication unit so that the at least one moves according to the modified moving scenario.

13. The vehicle control device of claim 10, wherein when generating the moving scenario, the processor sets a sub-leader vehicle leading a sub-group and a sub-follower vehicle that follows the sub-leader vehicle, and controls the communication unit so that the sub-group performs platooning according to the moving scenario.

14. The vehicle control device of claim 13, wherein when the sub-group is set, the processor limits the transmitting of the vehicle travel information to the sub-follow vehicle.

15. The vehicle control device of claim 14, wherein the processor resumes the transmitting of the vehicle travel information to the sub-follow vehicle when the sub-group is released.

16. The vehicle control device of claim 14, wherein the processor releases the sub-group based on a distance between the sub-leader vehicle and a vehicle positioned in front of the sub-leader vehicle.

17. The vehicle control device of claim 10, wherein the processor selects any one of the group vehicles as the sub-leader vehicle based on at least one of a position, type, height, length, and speed of each group vehicle.

18. A control method of a vehicle control device for controlling a vehicle, the method comprising:
transmitting vehicle travel information of the vehicle so as to cause a platooning with group vehicles included in a group;
determining the order number at which the new vehicle should be positioned in the group when a new vehicle is included in the group or scheduled to be included; and
controlling at least one of the new vehicle and the group vehicles so that the new vehicle is positioned at the order number.

19. The control method of claim 18, wherein the controlling of the at least one of the new vehicle and the group vehicles comprises:
generating the at least one moving scenario of the new vehicle and the group vehicles for which the new vehicle is positioned at the order number; and
controlling the at least one based on the moving scenario.

20. The control method of claim 19, wherein the controlling of the at least one of the new vehicle and the group vehicles further comprises:
setting a sub-leader vehicle leading a sub-group and a sub-follow vehicle following the sub-leader vehicle; and
controlling the sub-leader vehicle so that the sub-group performs a platooning according to the moving scenario.
